(19) United States
(12) Patent Application Publication
(10) Pub. No.: US 2006/0173836 A1
(43) Pub. Date: Aug. 3, 2006

(54) Method for selecting products of a process automation engineering device via internet

(75) Inventors: Joachim Neuhaus, Steinen (DE); Harald Freimark, Lorrach (DE)

Correspondence Address: BACON & THOMAS, PLLC, 625 SLATERS LANE, FOURTH FLOOR, ALEXANDRIA, VA, 22314, US

(73) Assignee: ENDRESS + HAUSER GMBH = co. kg, MAULBURG (DE)

(21) Appl. No.: 10/539,115

(22) PCT Filed: Dec. 8, 2003
(86) PCT No.: PCT/EP03/13893

§ 371 Date: Feb. 6, 2006

(30) Foreign Application Priority Data
Dec. 20, 2002 (DE) 102 60 960.8

(51) Int. Cl. G06F 17/30

(52) U.S. Cl. 707/5

(57) ABSTRACT

In a method for selecting products via the Internet, an Internet connection is established between a customer-side client-computer, which contains a planning module, and a manufacturer-side server, which contains a product database. After selecting at least one product line from the product database by querying of basic data via the Internet, a first identifier characterizing the selected product line is transmitted to the client-computer by the server. The specifying of a product of the product line is done with the help of the planning module by local querying of application data at the client-computer using the planning module. The first identifier can then be expanded to a second identifier uniquely characterizing the specified product. No transmitting of application data to third parties via the Internet is required.

The invention relates to a method for product selection of a process automation engineering device via the Internet, wherein an Internet-connection is established between a customer-side client-computer and a manufacturer-side server.

In many branches of industry, the selection and ordering of products via the Internet is now a matter of course. The customer, in such case, selects a product conveniently from home, or work, from an online-catalog, and orders such, when it meets the requirements.

Product selection is relatively easy and new products are available online immediately.

In the field of process automation engineering, product selection is somewhat more complicated than in the case of consumer goods. Measuring devices must be exactly planned for the intended application. For the field of Coriolis mass flow meters, a “Remote-Coriolis-Flowmeter-Sizing and Ordering System” is known from WO 02/44661 A2. In this case, the selection and ordering occurs e.g. via Inter- or intra-net. For the fields of fill-level and flow, the firm Endress+Hauser has Applicator® software, which is available in CD-ROM or by download via Internet.

Especially for the field of radiometric measurement systems, WO 02/061513 of the firm Endress+Hauser discloses a method for determining and presenting an optimized arrangement and assembly of a radiometric measurement system. Also, in this case, selection of the measurement system can occur via Internet.

For the exact specifying of the desired product, a considerable data exchange is necessary via Internet. Besides the basic data, which serves, essentially, for selecting the measurement principle (flow, pressure, fill level), also still needed to be exchanged between customer and manufacturer are application data, such as process parameters and/or data concerning the medium. In the case of application data, a customer does not like to share such very sensitive information with third parties. Application data permit, for instance, conclusions to be made concerning process conditions, and, thus, as regards operating secrets, especially in the field chemicals/pharmaceuticals. This is a reason why product selection via Internet for process automation is used only hesitatingly or even not at all.

An essential advantage in the case of product selection via Internet is that the manufacturer makes available to the customer, and selections are made from, a product database which is always current. Changes for products are made immediately in the product database by the manufacturer and, therefore, are immediately available to the customer. The product database is always current and, since a simple “single-source” data source is involved, it is easy to maintain.

An alternative method of product selection is one in which the manufacturer makes available to the customer a selection program, which is delivered in CD-Rom. The selection program runs locally on a computer at the customer's location and does not require any sharing of data with third parties. An example of such a selection program is the CD-ROM version of the Applicator® software of Endress+Hauser. A disadvantage of such a selection program on CD-ROM is that, in the installation of the program, especially in the case of networked computers, certain authorizations (administrator rights) are necessary. Such administrator rights are, however, not possessed by every employee. Thus, installation can only be done by an authorized circle of individuals.

This results in considerable delays in the installation. A further disadvantage of this method is that the ordering of a device is done classically by letter and/or telephone. In such case, it is possible that errors will arise in the transmission of the ordering codes. A further, significant disadvantage of this method is that the selection program is not updatable. So, new products are not available to the customer, or the customer can possibly select products which are no longer deliverable. This is then discovered only after contact is made with the manufacturer.

Another method is to offer the selection program as a download via the Internet. In this way, the most current version of the selection program would always be available to the customer. However, because of the amount of data (Applicator® ca. 100 MB), significant download times of up to 30 minutes, and more, result, which are not accepted from the customer-side. Also here, administrator rights are required for the program installation, and this can lead to the delays discussed above.

An object of the present invention is, therefore, to provide a method for product selection via Internet, which method makes available to the customer, in simple manner, all currently selectable products, while requiring no Internet exchange of application-related data, which might e.g. enable reverse-engineering to operating secrets.

This object is achieved by the method defined in claim 1.

An essential idea of the invention is that the customer first selects a product line, i.e. device-type, utilizing a query of basic data via Internet from a product database located with the manufacturer. Following the selection, a first identifier characterizing the product line is transmitted from the manufacturer-side server to the customer-side client computer. The exact specification of a product from the product line then occurs with the help of a planning module by local query of special application data, directly on the client computer of the customer. The planning module expands the first identifier to a second identifier, which uniquely characterizes the product.

In a last method step, the second identifier is transmitted to the manufacturer-side server and, as required, an order is released.

An essential idea of the invention is that a pre-selection of a product line is made via Internet, and the exact specifying of the product is done locally on the customer-side. An essential advantage of the method of the invention is that no application data, which could include operating secrets, must be shared with third parties.

Advantageous embodiments of the invention are contained in the dependent claims.

The invention will now be explained in greater detail on the basis of an example of an embodiment presented in the drawing, the figure of which shows as follows:

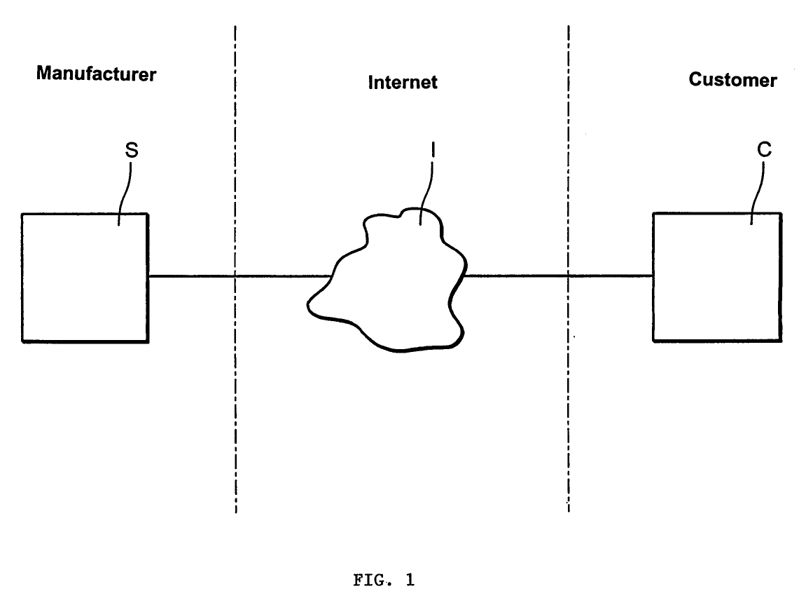

FIG. 1 a schematic representation of a computer connection via Internet.

For performing the method of the invention, an Internet connection is necessary between a customer-side client-computer C and a manufacturer-side server S. The simplest version of such a connection is shown. Of course, both the client computer C and the server S can be tied-in to other networks (company networks).

The method of the invention will now be explained in greater detail. In a first method step, an Internet connection is established between the customer-side client-computer C and the manufacturer-side server S. The customer-side client-computer C contains a planning module, which is needed for the exact specifying of the product. The server S contains a product database, in which various products of the manufacturer are stored with certain properties, as will as supplemental information, such as operating instructions, certificates, etc. By query of the basic data, at least one product line is selected from the product database with the help of an appropriate program. In the way of basic data, e.g. the measurement principle (flow, pressure, fill level) is requested. An example of a product line is the Promass 83 of the firm Endress+Hauser. The basic data are kept so general, that no conclusions concerning the specific application on the customer-side are possible. For this reason, there are no reservations on the customer-side concerning exchanging such data over the Internet.

Then, the first identifier characterizing the selected product line is transmitted from the server S to the client-computer C. With the help of the planning module, to which the product line is known via the first identifier, the product is then specified more exactly on the customer-side client-computer C. For this, specific application data are queried. The application data can involve e.g. process parameters and/or data concerning the medium. the process parameters characterize an application very exactly. Thus, e.g. the pressure range (minimum pressure, maximum pressure, nominal pressure) is queried. The same holds for the temperature range of the application. In the case of the data on the medium, it is, most often, what medium is being used; as required, other specific properties of the medium, such as viscosity and vapor pressure for the selected pressure and temperature ranges, are queried. In the case of some applications, especially in the case of radiometric applications, the exact tank geometry is queried. The published content of the commonly owned application WO 02/061513 already mentioned above is expressly incorporated here by reference.

The planning module includes a calculating module, which determines measuring-principle-specific characterizing-variables. This requires complicated calculations, based on the application data. Examples of measuring-principle-specific characterizing-variables are e.g., in the field of Coriolis mass flow meters, the minimum pressure loss, or maximum pressure loss, as the case may be, occurring in the measuring tube, as well as the minimum and maximum accuracy of the value of volume flow, or mass flow, also as the case may be. The specific application data are only queried and evaluated by the client-computer C. No transmission of data via intra-, or Inter-, net takes place.

On the basis of the calculated characterizing-variables, the planning module determines a device, whose device parameters fit such calculated characterizing-variables. The device is more accurately specified e.g. by nominal diameter, material, etc. At this stage of the selection, the customer still has the opportunity to make changes which it desires, for example with respect to nominal diameter. Following changes of this type, the characterizing-variables must be re-calculated.

After the accurate specifying of the product, the planning module expands the first identifier to a second identifier, which more accurately characterizes the product. The second identifier can be e.g. a complete ordering code. For ordering a selected product, the ordering code is transmitted to the server and the ordering process is, in this way, simply and certainly initiated.

Of course, the second identifier can also serve for further processing on the server-side. The customer can then again continue the selection process online. Perhaps color, or connections, must still be specified more accurately. Only after these device features are determined is a complete ordering code present, with which an order is possible.

The first identifier can be e.g. a part of an ordering code.

In the method of the invention, there is a strict separation between the selection of a product-line (selection) and the accurate specifying of a product of the product-line with the help of various calculations. In very simple manner, a selection by hand is illustrated e.g. in the publication “Radar Auswahlhilfe”, or “Radar Selection Guide”, of Endress+Hauser, respectively Document Nos. SD114F/00/de/06.01 and SD114F/00/en/06.01. The German-speaking world has adopted the term “sizing” for the calculation of characterizing-variables in process automation engineering. In the present invention, selection is done via Internet, while sizing occurs locally. The advantage of the method of the invention for the customer is that, in the Internet, a complete and current selection of the products of the manufacturer is available and, at the same time, no sensitive data must be shared with third parties. Of course, the planning module must also be updated at regular intervals, when data relevant for the planning module change—thus, for instance, when a Coriolis mass flow meter with a new nominal diameter is brought into the product program.

An updating of the planning module is, however, significantly less frequently necessary than the updating of the product database on the manufacturer-side. Most updatings are irrelevant for the planning module. The product database, including the stored operating instructions and certificates, includes, in the case of Endress+Hauser, about 800 different products and must, therefore, be updated almost daily. An updating of the planning module is, however, only necessary about half-yearly. Such an updating rate is accepted by the customer. The method of the invention can be used not only in the field of process automation engineering but also in all fields where a customer does not want to share with third parties certain information needed for the selection and/or ordering of a product.

1-9. (canceled)

10. A method for product selection of a device of process automation engineering via the Internet, comprising the steps of:
establishing an Internet connection between a customer-side client-computer, which contains a planning module, and a manufacturing-side server, which contains a product database;
selecting at least one product line from the product database by query of basic data via the Internet;
transmitting from the server to the client-computer a first identifier characterizing the selected product line;
specifying a product of the product line with the help of the planning module, by local query of application data at the client-computer; and
expanding the first identifier to a second identifier, which more accurately characterizes the specified product.

11. The method as claimed in claim 10, wherein:
for ordering, the second identifier is transmitted to the server.

12. The method as claimed in claim 10, wherein:
the basic data include the measuring principle.

13. The method as claimed in claim 10, wherein:
the application data includes process parameters and/or data concerning a medium.

14. The method as claimed in claim 10, wherein:
the planning module has a calculating module, which determines measurement-principle-specific variables.

15. The method as claimed in claim 14, wherein:
a measurement-principle-specific, characterizing-variable is e.g. measurement accuracy.

16. The method as claimed in claim 10, wherein:
the planning module determines with the calculated characterizing-variables a device whose device parameters fit the characterizing-variables.

17. The method as claimed in claim 10, wherein:
the first identifier is a part of an ordering code of a device of the manufacturer.

18. The method as claimed in claim 10, wherein:
the second identifier is a complete ordering code of a device of the manufacturer.
